(19) United States
(12) Patent Application Publication
(10) Pub. No.: US 2021/0034800 A1
(43) Pub. Date: Feb. 4, 2021

(54) Adaptive Topology Optimization For Additive Layer Manufacturing

(71) Applicants: Thales Alenia Space Italia S.p.A. Con Unico Socio, Roma (IT); Politecnico Di Milano, Milano (IT)

(72) Inventors: Luca Soli, Roma (IT); Simona Perotto, Milano (IT); Stefano Micheletti, Milano (IT)

(73) Assignees: Thales Alenia Space Italia S.p.A. Con Unico Socio, Roma (IT); Politecnico Di Milano, Milano (IT)

(21) Appl. No.: 16/073,485

(22) PCT Filed: Nov. 22, 2017
(86) PCT No.: PCT/IB2017/057323

§ 371 Date: Jul. 27, 2018

(30) Foreign Application Priority Data
Nov. 22, 2016 (IT) 102016000118131

(51) Int. Cl. G06F 30/23; G06T 17/20

(52) U.S. Cl. CPC G06F 30/23; G06F 2111/04; G06T 17/20

(57) ABSTRACT

A computer-aided FEM-based structure design system is provided that operates to:
acquire an initial structure design configuration comprising:
   a design domain (Ω),
   an applied load (f), and
   constrained, unconstrained and loaded areas (Γ_{D}, Γ_{F}, Γ_{N});
compute an initial mesh (Tₕ⁰) of the design domain (Ω);
compute a topologically optimized structure model by iterating, until a termination criterion is fulfilled:
   computing an optimized structure topology by properly implementing the SIMP (Solid Isotropic Material with Penalization) algorithm based on a density function (ρ) that represents the distribution of the material in the structure;
   computing an anisotropic recovery-based a posteriori error estimator (η) that quantifies the error between the gradient of the exact structure material density (ρ) and the gradient of the FEM-computed approximation thereof,
   computing a metric (M^{k+1}) for anisotropic mesh adaptation based on the anisotropic recovery-based a posteriori error estimator (η), and
   computing an adapted anisotropic mesh (Tₕ^{k+1}) based on the metric (M^{k+1}).

### TECHNICAL FIELD OF THE INVENTION

The present invention concerns, in general, Finite Element Method (FEM)-based Computer-Aided Engineering (CAE) for structural free-form design, and, in particular Adaptive Free-Form Design Optimization.

The present invention finds advantageous, though not exclusive, application in the free-form design of structures for the subsequent Additive Layer Manufacturing (ALM). In fact, the present invention may also find application in the free-form design of structures for their subsequent Layerless Additive (casting techniques), Non-Additive (multi-axis machines, spark-machining, etc.), and mixed Additive-Subtractive Manufacturing.

### STATE OF THE ART

The emerging additive layer manufacturing provides designers with an enormous, previously unthinkable, variety of shapes for objects. It is based on the addition of material with the “quasi-absence” of tools, thus overcoming the limits of traditional manufacturing based on removal of material, in terms of freedom of the possible objects shapes.

Most commercial CAE-FEM softwares have been developed to design objects having a shape complexity limited by subtractive production constraints.

Additive manufacturing considerably broadens the freedom and complexity of the possible objects shapes, but also drastically increases the computational resources necessary for implementing CAE-FEM design. Optimal solutions therefore have to be found in a wider range of permissible configurations.

Free-form topology optimization based on iterative algorithms requires a vast number of FEM analysis iterations that result in a considerable increment of the computational time, especially when large structures are to be designed. For example, in the case of topology optimization performed with the iterative SIMP (Solid Isotropic Material with Penalization) algorithm, in some cases the computational capacities are exceeded with no useful results.

### OBJECT AND SUMMARY OF THE INVENTION

The object of the present invention is to overcome the limits of iterative optimization algorithms, also including those of the aforementioned SIMP algorithm, so as to considerably reduce the computational cost and, at the same time, provide a completely free-form topology optimization.

According to the present invention, a computer-aided system is provided for FEM-based structure design, as claimed in the appended claims.

### BRIEF DESCRIPTION OF DRAWINGS

FIG. 1 schematically shows a computer-aided system to FEM-based structure design according to the present invention.

FIG. 2 shows a block diagram of the operations implemented by the computer-aided system according to the present invention.

FIG. 3 shows anisotropic quantities of a generic mesh element.

FIG. 4 shows benefits resulting from isotropic and anisotropic mesh adaptations with respect to a uniform mesh.

### DETAILED DESCRIPTION OF PREFERRED EMBODIMENTS OF THE INVENTION

The present invention will now be described in detail with reference to the accompanying drawings to enable those skilled in the art to embody and use it. Various modifications to the described embodiments will be immediately appreciable to those skilled in the art, and the generic principles described herein can be applied to other embodiments and applications without departing from the scope of the present invention, as defined in the appended claims. Thus, the present invention is not intended to be limited to the disclosed embodiments, but is to be accorded the widest scope consistent with the principles and features described and claimed.

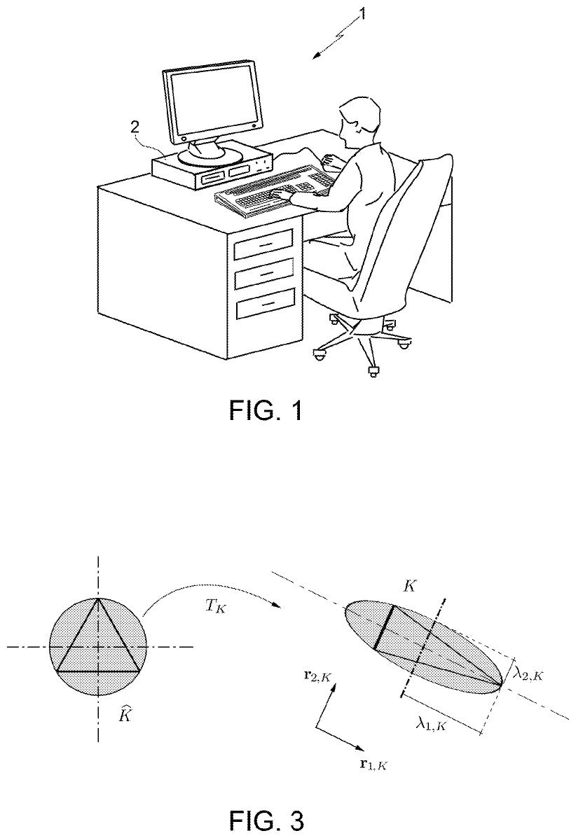

FIG. 1 schematically shows a computer-aided system, designated as a whole by reference number 1, for FEM-based structure design for subsequent additive layer manufacturing.

The computer-aided system 1 basically comprises a computer 2 with a user input device, in the example shown comprising a keyboard and a mouse, and a graphical display device, in the example shown in the form of a screen.

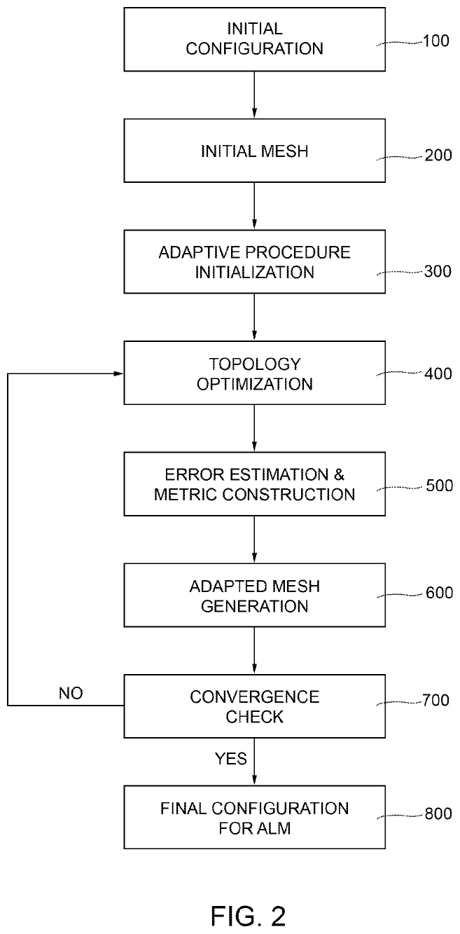

Computer 2 basically comprises a processor and an internal and/or external memory device, in which a program for structural design based on the finite element method is stored, and which, when executed by the processor, causes the computer 2 to become programmed to implement an improved SIMP algorithm, hereinafter referred to as SIMPATY for brevity, comprising the operations hereinafter described with reference to the flow chart shown in FIG. 2.

In particular, as shown in FIG. 2, the computer 2 is programmed to acquire (block 100) an initial structure design configuration, which can be entered by an operator via the user input device and comprises:
a design domain 1,
a constrained boundary portion Ω,
an unloaded boundary portion Γ_{D},
a loaded boundary portion Γ_{N}=∂Ω/(Γ_{D}∪Γ_{F}),
an applied load f, whether superficial, inertial, concentrated or distributed,
Young's modulus E of the material, and
Poisson ratio ν.

Initial structure design configuration is then used by the computer 2 in the standard linear elasticity equations to compute a displacement of the structure being designed, when loaded with load f on boundary portion Γ_{N} and constrained on boundary portion Γ_{D}.

Computer 2 is further programmed to compute (block 200) an initial mesh Tₕ⁰ for the design domain Ω, by using any mesh generation software available in the literature.

Computer 2 is further programmed to receive (block 300) control parameters, described in more detail hereinafter and indicated as CTOL, MTOL and ρₘᵢₙ, intended to control the structure topology optimization, described further on with reference to block 400, and the anisotropic mesh adaptation described further on with reference to blocks 500, 600 and 700.

Computer 2 is further programmed to iteratively repeat the operations of topology optimization and of anisotropic mesh adaptation driven by an anisotropic recovery-based a posteriori error estimator, hereinafter described with reference to blocks 400 to 700, which represent the core of the SIMPATY algorithm, which combines the reliability and computational easiness of an anisotropic recovery-based a posteriori error estimator with the effectiveness of an anisotropic mesh adaptation.

As is known, structural topology optimization is a mathematical approach through which the layout of the material of the structure being designed in the design domain Q is optimized, under the load and constraint conditions specified in the initial design configuration, in such a way that the resulting layout satisfies given design and performance targets.

Mesh adaptation is instead a numerical procedure that improves the performance of a finite element solver by modifying the size of the mesh elements, which in 2D are typically of a triangular or square shape, while in 3D they are usually tetrahedral or hexahedral. In particular, the aim of mesh adaptation is to make the mesh elements to be smaller where the phenomenon to be investigated exhibits more complex local characteristics, and to instead use larger mesh elements where the physical solution is regular.

Unlike a standard structured mesh, where the size of a mesh element is uniform over the entire domain, an adapted mesh allows reducing the number of mesh elements, i.e., the size of the finite element algebraic system, for the same solution accuracy, or to increase solution accuracy for the same number of mesh elements.

Independently of the criterion adopted, the computational advantages deriving from the use of adapted meshes are appreciable and now consolidated in the literature. Adapted meshes can be classified into isotropic or anisotropic meshes depending on their geometric characteristics.

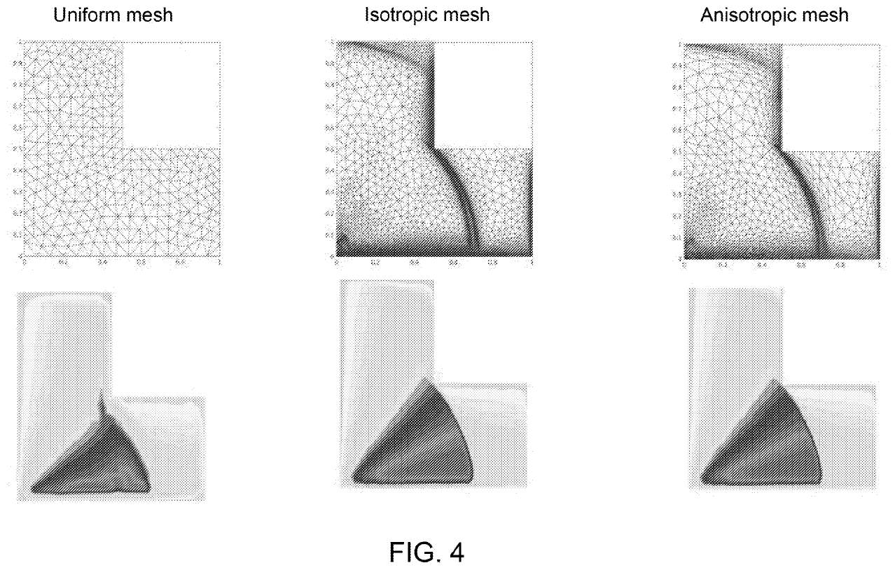

Isotropic meshes are formed by very regular and (quasi-) equilateral elements, and the only quantity that changes is the size, i.e. the diameter (see FIG. 4, middle picture).

Conversely, anisotropic meshes can be characterized by highly elongated elements, thus allowing control of the size, shape and orientation of the elements (see FIG. 4, right-hand picture), thereby introducing greater freedom in the computational mesh design. In particular, this flexibility is found to be ideal for describing physical problems characterized by high directionality, as long as the mesh elements are aligned with these directional characteristics, for example, shocks in compressible streams in aerospace applications, multi-material flows with abrupt immiscible interfaces in 3D and ALM printing, and boundary layers in viscous flows around bodies or walls.

Since they only allow adjusting the size of the mesh elements, standard isotropic meshes are not able to capture these directional characteristics, while the adaptation of an anisotropic mesh is a powerful tool for improving the quality and efficiency of finite element procedures. By way of example, FIG. 4 shows the effect of adaptation on an isotropic mesh (middle picture) and on an anisotropic mesh (right-hand picture) of an advection-diffusion problem in an L-shaped domain, where the solution shows two inner circular layers and three boundary layers. The accuracy of the solutions based on the two adapted meshes is clearly greater than that based on the uniform mesh. For the same solution accuracy, the number of mesh elements for the isotropic and anisotropic meshes is 24,499 and 5,640, respectively.

Mesh adaptation can be implemented through heuristic or theoretical criteria. Heuristic approaches basically employ information related to the derivatives of the numerical solution, such as the solution's gradient or Hessian. Instead, the theoretical approaches are based on sound mathematical tools, known as error estimators, which provide explicit control of the discretization error in terms of the exact solution (a priori error estimators) or of directly computable quantities (a posteriori error estimators).

Popular a posteriori error estimators include those that are recovery-based (based on gradient reconstruction), residual-based (based on the residual associated with the discrete solution), and dual-based (based on the error associated with a physical quantity of interest).

Recovery-based a posteriori error estimators were proposed by O. C. Zienkiewicz and J. Z. Zhu in 1992 and are widely used in the engineering field due to their excellent properties. Recovery-based a posteriori error estimators are not confined to a specific problem, are independent of discrete formulation (except for the selected finite element space), are cheap to compute, easy to implement and work extremely well in practice.

The main idea underlying recovery-based a posteriori error estimators is to compute the discretization error by replacing the gradient of the exact solution with a discrete enriched (or reconstructed) gradient with respect to the gradient of the FEM solution.

However, the recovery-based a posteriori error estimators introduced by O. C. Zienkiewicz and J. Z. Zhu in 1992 were confined to an isotropic context, while their anisotropic counterpart was proposed by S. Micheletti, S. Perotto in Anisotropic adaptation via a Zienkiewicz-Zhu error estimator for 2D elliptic problems, Numerical Mathematics and Advanced Applications 2009, Proceedings of ENUMATH 2009, the 8th European Conference on Numerical Mathematics and Advanced Applications, Uppsala, July 2009, Gunilla Kreiss, Per Lotstedt, Axel Malqvist, Maya Neytcheva Editors, Springer-Verlag Berlin, pp. 645-653, 2010, in the two-dimensional case, and subsequently, in the three-dimensional case by P. E. Farrell, S. Micheletti, S. Perotto in A recovery-based error estimator for anisotropic mesh adaptation in CFD, Bol. Soc. Esp. Mat. Apl., 50, 115-137 (2010), and by P. E. Farrell, S. Micheletti, S. Perotto in An anisotropic Zienkiewicz-Zhu type error estimator for 3D applications, Int. J. Numer. Meth. Engng, 85 (6), 671-692 (2011).

Instead, the combination of a topology optimization with an anisotropic mesh adaptation driven by heuristic criteria based on data provided by the Hessian of the design variable (density of the material) combined with the Hessian of the cost functional with respect to the design variable, and where all the quantities involved in the Hessians are preliminarily filtered, is proposed by K. E. Jensen in Anisotropic mesh adaptation and topology optimization in three dimensions, J. Mech. Design, doi:10.1115/1.4032266, by K. E. Jensen in Solving stress and compliance constrained volume minimization using anisotropic mesh adaptation, the method of moving asymptotes and a global p-norm, Struct. Multidisc. Optim., doi: 10.1007/s00158-016-1439-9, by K. E. Jensen in Optimising Stress Constrained Structural Optimisation, Research Note, in 23rd International Meshing Roundtable (IMR23), 2014, and by K. E. Jensen and G. Gorman in Anisotropic Mesh Adaptation, the Method of Moving Asymptotes and the global p-norm Stress Constraint, arXiv preprint arXiv:1410.8104.

Unlike the solutions proposed in the aforementioned literature, the present invention proposes a synergetic combination of a topology optimization with an anisotropic mesh adaptation driven by an anisotropic recovery-based a posteriori error estimator, rather than by a heuristic approach, and without necessarily performing any kind of filtering, in order to develop a CAE-FEM design tool aimed at free-form design, with lower computational costs with respect to those associated with other adaptation methods and with a rigorous procedure from the theoretical standpoint.

The present invention differs from what proposed in the aforementioned articles of S. Micheletti and S. Perotto, Anisotropic adaptation via a Zienkiewicz-Zhu error estimator for 2D elliptic problems, A recovery-based error estimator for anisotropic mesh adaptation in CFD, and An anisotropic Zienkiewicz-Zhu type error estimator for 3D applications, since in the estimator proposed in these articles for the two-dimensional and three-dimensional cases, respectively, is used for the first time in the present invention to drive a topology optimization procedure. No mention at all of a topology optimization is made in these articles.

The present invention further differs from what is proposed by K. E. Jensen in the aforementioned articles Anisotropic mesh adaptation and topology optimization in three dimensions, Solving stress and compliance constrained volume minimization using anisotropic mesh adaptation, the method of moving asymptotes and a global p-norm, Optimising Stress Constrained Structural Optimisation, and Anisotropic Mesh Adaptation, the Method of Moving Asymptotes and the global p-norm Stress Constraint, since the anisotropic mesh adaptation is driven by a theoretical tool, namely a recovery-based a posteriori error estimator, rather than by heuristic criteria.

The advantages deriving from the combination proposed in the present invention between a recovery-based a posteriori error estimator and an anisotropic mesh adaptation procedure driven by this estimator, compared to the procedure proposed by K. E. Jensen based on anisotropic mesh adaptation driven by a heuristic estimator, have been verified in the test case shown in FIG. 9 of the article of K. E. Jensen Anisotropic mesh adaptation and topology optimization in three dimensions.

In particular, the comparison has been carried out for the same number of nodes in the final adapted grid (3,833 nodes for the SIMPATY algorithm versus 3,121 nodes for K. E. Jensen's algorithm), and minimising a target function defined, in this case, by the compliance, namely the yieldingness of the final structure. The output structure of SIMPATY algorithm was characterized by a compliance equal to 1.31144, versus a compliance computed by K. E. Jensen's algorithm equal to 1.5529, so showing that the SIMPATY algorithm results in a more performant structure, namely more rigid.

Furthermore, the comparison shows the extensive difference between the two algorithms in terms of execution times, on computers with similar characteristics. In particular, the execution time of the SIMPATY algorithm was equal to 0.9 hours, versus the 3.3 hours of K. E. Jensen's algorithm.

To implement the SIMPATY algorithm, the computer 2 is first programmed to compute an optimized topology (block 400) of the structure being designed by properly implementing the aforementioned iterative SIMP algorithm. As is known, this is based on a density function p that may range in [ρₘᵢₙ, 1] and which represents the distribution of material in the structure (ρₘᵢₙ=material absent (empty), 1=material present (full)), and on the basis of which Young's modulus E is replaced by an effective modulus E←ρ^{p} E, where p=3 is a penalty exponent. The result of the topology optimization is represented by an optimized density function pₒₚₜₘ.

In an alternative embodiment, instead of the iterative SIMP algorithm, the topology optimization could be performed by using any other topology optimization algorithm based on a density function ρ or on its generalization (known in the literature as phase field).

The computer 2 is further programmed to first compute (block 500) an anisotropic recovery-based a posteriori error estimator η that quantifies the error between the gradient of the exact density ρ and the gradient of its FEM approximation, and then compute a metric M based on this anisotropic estimator, as better described hereinafter. Both η and M are then used to compute a new adapted anisotropic mesh.

In particular, the mathematical tool that drives the adaptation of the anisotropic mesh is represented by a global anisotropic recovery-based a posteriori error estimator η that collects the local anisotropic recovery-based a posteriori error estimators η_{K} of all the elements K of the mesh Tₕ, with:

$${η}^{2} = {\sum }_{K ∈ {T}_{h}} {η}_{K}^{2}$$

The local anisotropic recovery-based a posteriori error estimator η_{K} associated with the element K of mesh Tₕ tracks the relevant anisotropic geometrical characteristics of the element K, together with the typical structure of an anisotropic recovery-based a posteriori error estimator.

As proposed in the aforementioned article Anisotropic adaptation via a Zienkiewicz-Zhu error estimator for 2D elliptic problems, the local anisotropic recovery-based a posteriori error estimator η_{K} may be computed as follows:

$${η}_{K}^{2} = \frac{1}{{λ}_{1 , K} {λ}_{2 , K}} {\sum }_{i = 1}^{2} {λ}_{i , K}^{2} ( {r}_{i , K}^{T} {G}_{{Δ}_{K}} ( {E}_{∇} ) {r}_{i , K} )$$

where Γ_{Δ}_{_{K}} is the positive semi-definite symmetric matrix:

$$[ {G}_{{Δ}_{K}} ( w ) ] = {\sum }_{T ∈ {Δ}_{K}} {\int }_{T} {w}_{i} {w}_{j} dx i , j = 1 , 2$$

where:

w=(w₁w₂)^{T} is a generic vector-valued function, and

Δ_{K}={T∈T_h:T∩K≠0} is the patch of mesh elements associated with K.

The anisotropic characteristics of element K of the mesh Tₕ are represented by the quantities λ_{i,K} and r_{i,K}, for i=1, 2, which define the length and direction of the semi-axes of the ellipse circumscribing element K, with λ_{1,K}≥λ_{2,K} (see FIG. 3).

The “recovery-based” nature of the local anisotropic estimator η_{K} is instead represented by the quantity

$${E}_{∇} = {[ P ( {∇}_{{ρ}_{h}} ) - {∇}_{{ρ}_{h}} ]}_{{Δ}_{K}} ,$$

i.e. by the (recovered error) difference between the gradient ∇_{ρ}_{ₕ} of the discrete density ρₕ and a suitable reconstruction P(∇_{ρ}_{ₕ}) of this gradient, confined to the patch of elements Δ_{K}.

The technique proposed in the aforementioned Anisotropic adaptation via a Zienkiewicz-Zhu error estimator for 2D elliptic problems is adopted for the reconstruction P(∇_{ρ}_{ₕ}) of the gradient ∇_{ρ}_{ₕ}:

$$P ( {∇}_{{ρ}_{h}} ) {\vert}_{{Δ}_{K}} = \frac{1}{\vert {Δ}_{K} \vert} {\sum }_{T ∈ {Δ}_{K}} \vert T \vert {∇}_{{ρ}_{h}} {\vert}_{T}$$

i.e. the weighted average of the area of the discrete gradients associated with the triangles of the patch Δ_{K} is considered.

At each iteration k of the iterative procedure, starting from mesh Tₕ^{k}, a metric M^{k+1} defined by new values of λ_{i,K} and r_{i,K} is then computed, based on the local anisotropic estimators η_{K}, which minimizes the number of mesh elements while at the same time ensuring a certain accuracy.

The new values of the quantities λ_{i,K} and r_{i,K} are computed on the basis of an error equidistribution criterion, according to which η_{K} is approximately constant on every element of the new adapted mesh Tₕ^{k+1}, combined with the minimization of the number of elements in the mesh Tₕ^{k+1}, which guarantees a certain accuracy MTOL on the discretization error (in practice, on η).

Computer 2 is further programmed to compute an adapted anisotropic mesh Tₕ^{k+1} based on the previously computed metric M^{k+1} and using a suitable mesh generator (block 600).

Computer 2 is further programmed to monitor (block 700) the convergence of the SIMPATY algorithm based on the outcome of two checks, the first of which is for checking the maximum number kₘₐₓ of iterations, while the second is for checking stagnation in the iterative procedure, interrupting the iterative procedure when the relative change in mesh cardinality (number of mesh elements) in successive iterations is less than a threshold CTOL, thus returning a topologically optimized structure model ready for use in additive layer manufacturing and defined by an adapted anisotropic mesh Tₕ and an optimized density function ρₒₚₜₘ (block 800).

Pseudo-code of the SIMPATY algorithm is shown below. The input data consists of the aforementioned CTOL, MTOL, kₘₐₓ, ρₘᵢₙ and Tₕ⁰ parameters, where CTOL is the mesh cardinality stagnation control parameter, MTOL defines the discretization error accuracy, kₘₐₓ represents the maximum number of iterations, ρₘᵢₙ represents the minimum density value of the structure that identifies the absence of material (empty), and Tₕ⁰ represents the initial mesh of the design domain Ω computed in block 200.

Input : CTOL, MTOL, kmax, ρₘᵢₙ, Tₕ⁰
Set : ρₕ⁰ ← 1, k ← 0, errC ← 1 + CTOL
while (errC > CTOL & k < kmax) then

ρₕ^{k+1} ←IPOPT(ρₕ^{k}, ρₘᵢₙ, MIT=10, TOPT=10⁻⁶, ...);
Tₕ^{k+1} ← adapt(Tₕ^{k}, ρₕ^{k+1},MTOL);
errC ← |#Tₕ^{k+1} − #Tₕ^{k}|/#Tₕ^{k};
k ← k + 1;

end

Topology optimization described with reference to block 400 is implemented by the Interior Point Optimizer IPOPT, which solves a generic constrained optimization problem.

Input data for the IPOPT function has been chosen as indicated in http://www.coin-or.org/lpopt/documentation/node10.html, even if, in principle, the operator can choose other values or resort to other optimization tools.

Instead, the anisotropic mesh adaptation described with reference to block 600 is implemented via the adapt function.

The two kernels IPOPT and adapt are linked by the key quantity ρ^{k} which defines the FEM discrete density, piecewise linear, at generic iteration k.

SIMPATY algorithm thus iteratively alternates topology optimization and anisotropic mesh adaptation driven by an anisotropic recovery-based a posteriori error estimator until either mesh cardinality stagnation or the maximum number of iterations is reached.

The SIMPATY algorithm enables overcoming the limits of the SIMP algorithm extremely well, considerably reducing the computational cost by a factor of roughly three in terms of degrees of freedom, at the same time providing a completely free-form topology optimization.

1. A computer-aided FEM-based structure design system (1) configured to:
acquire (100) an initial structure design configuration comprising:
a design domain (Ω),
an applied load (f), and
constrained, unconstrained and loaded areas (Γ_{D}, Γ_{F}, Γ_{N});
compute (200) an initial mesh (Tₕ⁰) of the design domain (Ω);
compute a topologically optimized structure model by iterating, until a termination criterion is fulfilled:
computing (400) an optimized structure topology;
computing (500) an anisotropic recovery-based a posteriori error estimator (η) that quantifies the error between the gradient of the exact structure material density (ρ) and the gradient of the FEM-computed approximation thereof; and
computing (600) an adapted anisotropic mesh (Tₕ^{k+1}) based on the anisotropic recovery-based a posteriori error estimator (η).

2. The computer-aided FEM-based structure design system (1) according to claim 1, further configured to:
compute (500) a metric (M^{k+1}) for anisotropic mesh adaptation based on the anisotropic recovery-based a posteriori error estimator (η), and
compute (600) the adapted anisotropic mesh (Tₕ^{k+1}) based on the metric (M^{k+1}).

3. The computer-aided FEM-based structure design system (1) according to claim 1, further configured to compute a topologically optimized structure model comprising an adapted anisotropic mesh (Tₕ) and an optimized density function (ρₒₚₜₘ).

4. The computer-aided FEM-based structure design system (1) according to claim 1, further configured to compute a global anisotropic recovery-based a posteriori error estimator (η) based on local anisotropic recovery-based a posteriori error estimators (η_{K}) associated with the elements (K) of the anisotropic mesh (Tₕ).

5. The computer-aided FEM-based structure design system (1) according to claim 4, wherein anisotropic features (λ_{i,K}, r_{i,K}) of an element (K) of the anisotropic mesh (Tₕ) comprise length and direction of semi-axes of an ellipse circumscribing the element (K) of the anisotropic mesh (Tₕ), and wherein the computer-aided FEM-based structure design system (1) is further configured to compute the anisotropic features (λ_{i,K}, r_{i,K}) of the elements (K) of the anisotropic mesh (Tₕ) based on an error equidistribution criterion, according to which the anisotropic recovery-based a posteriori error estimator (η_{K}) is approximately constant over the elements (K) of the adapted anisotropic mesh (Tₕ^{k+1}), and on minimization of the number of elements (K) of the adapted anisotropic mesh (Tₕ^{k+1}).

6. The computer-aided FEM-based structure design system (1) according to claim 1, further configured to compute an optimized structure topology by implementing a Solid Isotropic Material with Penalization (SIMP) algorithm.
